(19) United States
(12) Patent Application Publication
(10) Pub. No.: US 2026/0237029 A1
(43) Pub. Date: Aug. 13, 2026

(54) FLICKERING-FREE VIDEO DECODER

(71) Applicant: ADOBE INC., SAN JOSE, CA (US)

(72) Inventors: Ratheesh Kalarot, Hayward, CA (US); Mamshad Nayeem Rizve, Cupertino, CA (US); Chengyuan Xu, Sunnyvale, CA (US)

(21) Appl. No.: 19/369,517

(22) Filed: Oct. 27, 2025

Related U.S. Application Data
(60) Provisional application No. 63/755,469, filed on Feb. 7, 2025.

(51) Int. Cl. G06T 5/70; G06T 5/60; G06T 11/00

(52) U.S. Cl. CPC G06T 5/70; G06T 5/60; G06T 11/00; G06T 2207/10024; G06T 2207/20081; G06T 2210/61

(57) ABSTRACT

A method, apparatus, non-transitory computer readable medium, and system for video generation includes obtaining an input prompt describing a scene. A video generation model generates a first frame chunk and a second frame chunk based on the input prompt, wherein the first frame chunk includes a first token corresponding to a video frame and the second frame chunk includes a second token corresponding to the same video frame as the first token. Subsequently, the video generation model generates a synthetic video based on the set of frame tokens including the first frame chunk and the second frame chunk, wherein the synthetic video depicts the scene and includes the video frame.

### CROSS-REFERENCE TO RELATED APPLICATION

This application is based on and claims priority under 35 U.S.C. § 120 to U.S. Patent Application No. 63/755,469, filed on Feb. 7, 2025, in the United States Patent and Trademark Office, the contents of which are incorporated by reference herein in their entirety.

### BACKGROUND

The following generally relates to machine learning, and more specifically to video generation using a machine learning model. Machine learning algorithms build a model based on sample data, known as training data, to make a prediction or a decision in response to an input without being explicitly programmed to do so. One area of application for machine learning is video generation.

For example, a machine learning model can be trained to predict features for a video in response to an input prompt, and then generate the video based on the predicted features. In some cases, the prompt can be used to perform complex video manipulation and compositing. Such video generation provides for a user to edit a video and generate a modified video with desired features and therefore makes video generation easier for a layperson.

### SUMMARY

The present disclosure describes systems and methods for video generation. Embodiments of the present disclosure include a video generation model that generates a video based on an interpolation method. Embodiments of the present disclosure include the video generation model comprising a video decoder that performs an interpolation-based decoding. The video generation model divides an input video stream into a plurality of video segments. In some cases, the video decoder uses one or more key frames of each video segment of the plurality of video segments for the interpolation. For instance, the video generation model generates an intermediate video frame based on the interpolation of the key frames associated with the video segment.

A method, apparatus, and non-transitory computer readable medium for video processing are described. One or more aspects of the method, apparatus, and non-transitory computer readable medium include obtaining an input prompt describing a scene; generating, using a video generation model, a set of frame tokens including a first frame chunk and a second frame chunk based on the input prompt, wherein the first frame chunk includes a first token corresponding to a video frame and the second frame chunk includes a second token corresponding to the same video frame as the first token; and generating, using the video generation model, a synthetic video based on the set of frame tokens including the first frame chunk and the second frame chunk, wherein the synthetic video depicts the scene and includes the video frame.

A method, apparatus, and non-transitory computer readable medium for video processing are described. One or more aspects of the method, apparatus, and non-transitory computer readable medium include obtaining an input prompt describing a scene; generating, using a video generation model, a first intermediate video frame in a first frame chunk and a second intermediate video frame in a second frame chunk; and generating, using the video generation model, a synthetic video depicting the scene by blending the first intermediate video frame and the second intermediate video frame to obtain a video frame of the synthetic video.

An apparatus and system for video processing are described. One or more aspects of the apparatus and system include obtaining an input prompt describing a scene; generating, using a video generation model, a set of frame tokens including a first frame chunk and a second frame chunk based on the input prompt, wherein the first frame chunk includes a first token corresponding to a video frame and the second frame chunk includes a second token corresponding to the same video frame as the first token; and generating, using the video generation model, a synthetic video based on the set of frame tokens including the first frame chunk and the second frame chunk, wherein the synthetic video depicts the scene and includes the video frame.

### BRIEF DESCRIPTION OF THE DRAWINGS

FIG. 1 shows an example of a video processing system according to aspects of the present disclosure.

FIG. 2 shows an example of a method for video generation according to aspects of the present disclosure.

FIG. 3 shows an example of a video filling process according to aspects of the present disclosure.

FIG. 4 shows an example of a video processing apparatus according to aspects of the present disclosure.

FIG. 5 shows an example of a video generation model according to aspects of the present disclosure.

FIG. 6 shows an example of a method for video processing according to aspects of the present disclosure.

FIG. 7 shows an example of a method for video processing according to aspects of the present disclosure.

FIG. 8 shows an example of a method for video processing according to aspects of the present disclosure.

FIG. 9 shows an example of a method of training a machine learning (ML) model according to aspects of the present disclosure.

FIG. 10 shows an example of a method of training a diffusion model according to aspects of the present disclosure.

FIG. 11 shows an example of a computing device according to aspects of the present disclosure.

FIG. 12 shows an example of a video processing apparatus according to aspects of the present disclosure.

FIG. 13 shows an example of a video generation model according to aspects of the present disclosure.

### DETAILED DESCRIPTION

Existing systems use a diffusion network for video generation. In some cases, such systems generate a video in segments. For example, existing systems generate a plurality of video segments that are subsequently combined to generate a final video. However, such systems generate video segments that each include only 16 video frames (e.g., 16 RGB frames). As a result, existing systems generate videos that lack visual appeal and continuity.

Due to the limited number of video frames in each video segment, a video generated by an existing system includes displeasing flickering artifacts. For example, the generated video includes flickering artifacts at the seams between segments which results in generation of a visually unnatural or discontinuous video. In a case where the number of video frames in a segment is more than the standard 16 RGB frames, the computational requirement of the system increases significantly. As a result, while minimizing the resource requirements, an existing system is unable to maintain consistency and quality of the generated video.

By contrast, embodiments of the present disclosure include a video generation model that generates a video based on an interpolation method. Embodiments of the present disclosure include the video generation model comprising a video decoder that performs an interpolation-based decoding. The video generation model divides an input video stream into a plurality of video segments. In some cases, the video decoder uses one or more key frames of each video segment of the plurality of video segments. For instance, the video generation model generates an intermediate video frame based on interpolation of the key frames associated with the video segment.

The present disclosure describes systems and methods for video generation. Embodiments of the present disclosure include a video generation model that uses dual key frames among the plurality of key frames associated with the video segment. By using a dual key frame method for performing the interpolation to generate an artifact-free video, embodiments of the present disclosure are able to maintain temporal coherence across the plurality of video segments while reducing computational resources.

Embodiments of the present disclosure include a video generation model that performs video generation. The video generation model implements a dual key frame method for decoding each video segment of the plurality of video segments. In some cases, the video generation model implements the dual key frame method based on an overlapping key frame. For example, the video generation model uses the last frame of a first video segment as the first token of a second video segment, where the second video segment is subsequent to the first video segment.

In some cases, the video generation model performs an interpolation method. For example, the video generation model performs the interpolation of one or more frames corresponding to a video segment to generate interpolated frames. In some examples, the interpolated frames fill in the motion gaps between the key frames associated with each video segment. Accordingly, by performing interpolation of the frames, embodiments of the present disclosure are able to prevent occurrence of flickering artifacts while maintaining computational efficiency.

Embodiments of the present disclosure are configured to perform video generation. The video generation model of the present disclosure partitions an input video stream into a plurality of video segments. In some cases, the video generation model performs an interpolation method based on the dual key frame associated with each of the plurality of video segments. Therefore, by performing the interpolation method, the video generation model leverages minimal resources while enabling generation of a high-quality and seamless video that is applicable in production-scale.

As described herein, transformer-based diffusion models operate by performing attention operations on “tokens”, which are a sequence of vectors that represent the video being generated. In some cases, the tokens represent patches of the image, where each patch is iteratively denoised to generate image content, and after the denoising is complete, the patches are reconstructed to form the final video. According to some aspects, some tokens may need fewer processing operations than others during the iterative generation process of a video.

As described herein, a “frame chunk” refers to a contiguous sequence or subset of video frames extracted from a video segment. In some cases, a frame chunk comprises a fixed or variable number of frames sampled either uniformly or non-uniformly from a video stream and selected based on temporal boundaries, content characteristics, or motion cues. Each frame within the chunk may retain temporal ordering and can be processed for downstream tasks such as, but not limited to, video generation. In some cases, the frame chunk is used to reduce computational complexity by enabling windowed processing and may serve as an input to a generation model that operates on short-term spatiotemporal dynamics. In some embodiments, frame chunks are encoded into compact representations using video encoders to facilitate content understanding and synthesis. According to embodiments of the disclosure, a video generation model can generate two different frame chunks for a video that have overlapping frame tokens. That is, they can both have frame tokens corresponding to the same video frame to ensure temporal consistency across frame chunks.

As described herein, a “key frame token” in a frame chunk refers to a data representation that identifies or encodes a keyframe within a sequence of video frames. In some cases, the key frame token is used as a reference point for subsequent frames. In some cases, the key frame token includes metadata or compressed data that provides for efficient interpolation of video content.

As described herein, an “intermediate subset of video frames” refers to an interpolated frame that is generated to ensure smooth transitions between two key frames. In some cases, the intermediate subset of video frames is generated by performing an interpolation of two video frames in the pixel space.

As used herein, a video generation model may refer to a machine learning-based model configured to generate a media item, such as a video, based on input data. The model may include machine learning architectures, such as neural networks, generative adversarial networks (GANs), transformer-based models, or a diffusion network. In some cases, the video generation model may utilize trained parameters, latent representations, or probabilistic sampling techniques to generate an output that resembles or extends the input data while maintaining desired stylistic or structural attributes.

As described herein, a synthetic video refers to a time-ordered sequence of frames, or images. In some cases, the synthetic video depicts a temporally coherent sequence of image frames synthesized based on the input prompt. The synthetic video reflects both spatial structure and temporal dynamics, such as motion continuity, object persistence, and scene transitions, generated based on the video generation model.

By generating intermediate frames based on an interpolation method, embodiments of the present disclosure are able to ensure consistency across the plurality of video segments. Accordingly, by ensuring consistency in segments, embodiments are able to significantly enhance quality of the generated video resulting in increased use in professional and creative domains. Additionally, by performing an interpolation-based decoding method, embodiments of the present disclosure minimize resource utilization resulting in reduction of associated computational costs.

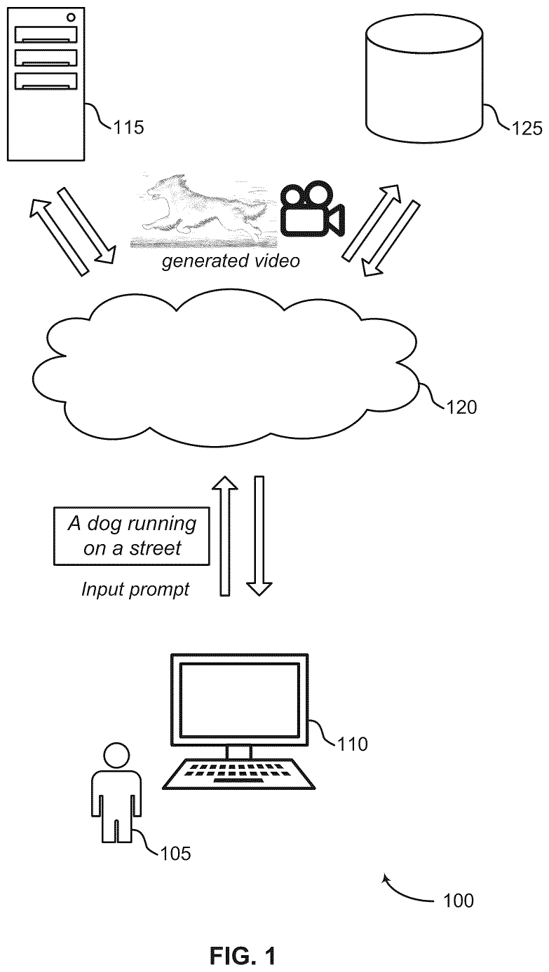

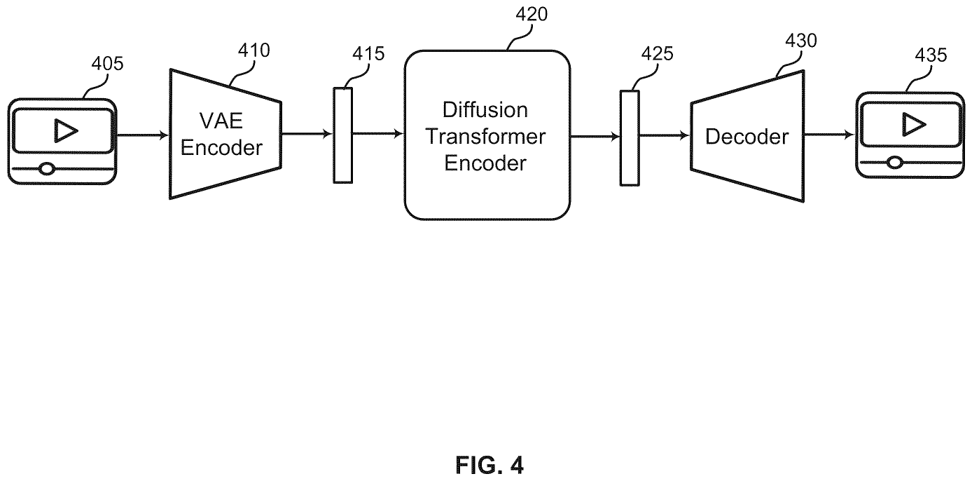

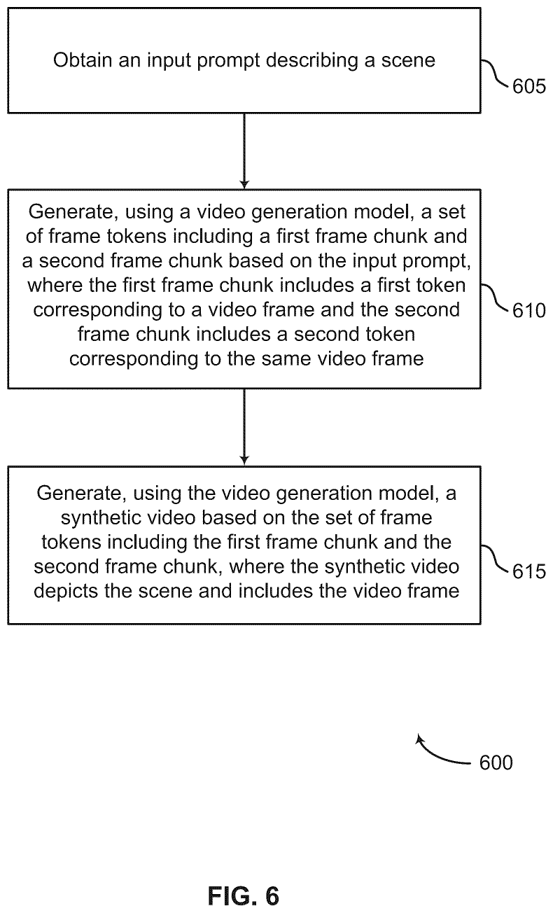

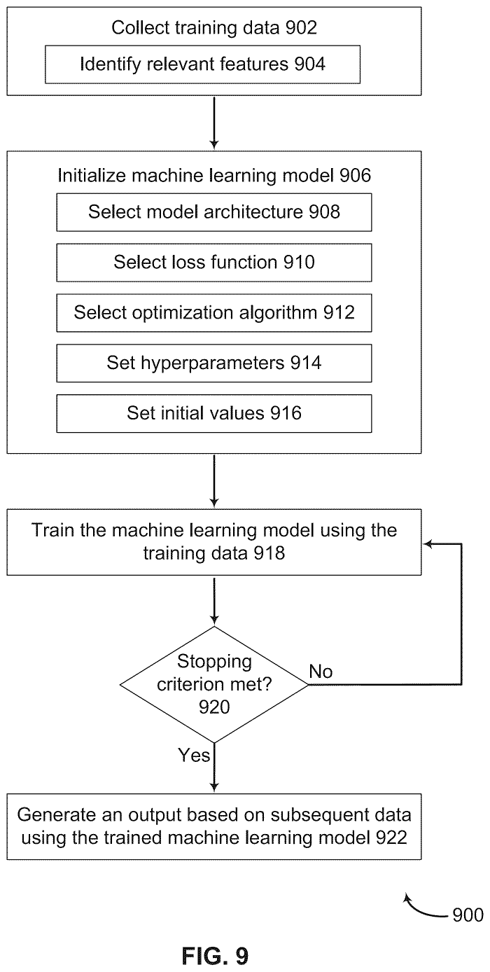

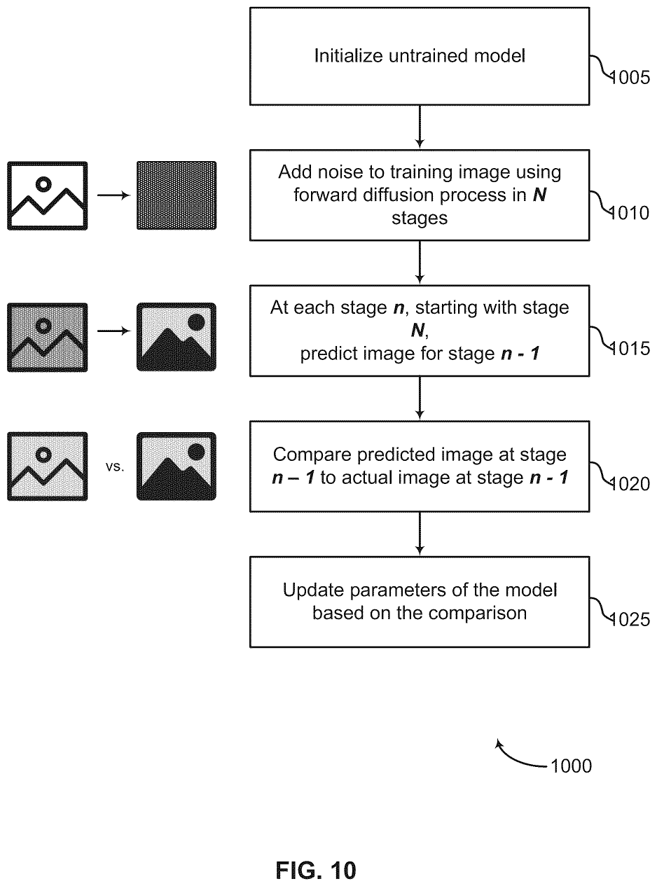

Embodiments of the present disclosure can be implemented in a video processing system. For example, the video processing system based on the present disclosure takes an input prompt (e.g., describing a target action) and generates a synthetic video that accurately depicts the target action described in the input prompt. Example applications regarding generating a video that depicts an element are provided with reference to FIGS. 1-3. Details regarding the architecture of the video generation model are provided with reference to FIGS. 4-5 and 11-13. Details regarding an operation of the video generation model are provided with reference to FIG. 6-8. Examples of a process for training the video generation model are provided with reference to FIGS. 9-10.

### Video Processing System

A system and an apparatus for video processing are described with reference to FIGS. 1-5. FIG. 1 shows an example of a video processing system 100 according to aspects of the present disclosure. In one aspect, video processing system 100 includes user 105, user device 110, video processing apparatus 115, cloud 120, and database 125.

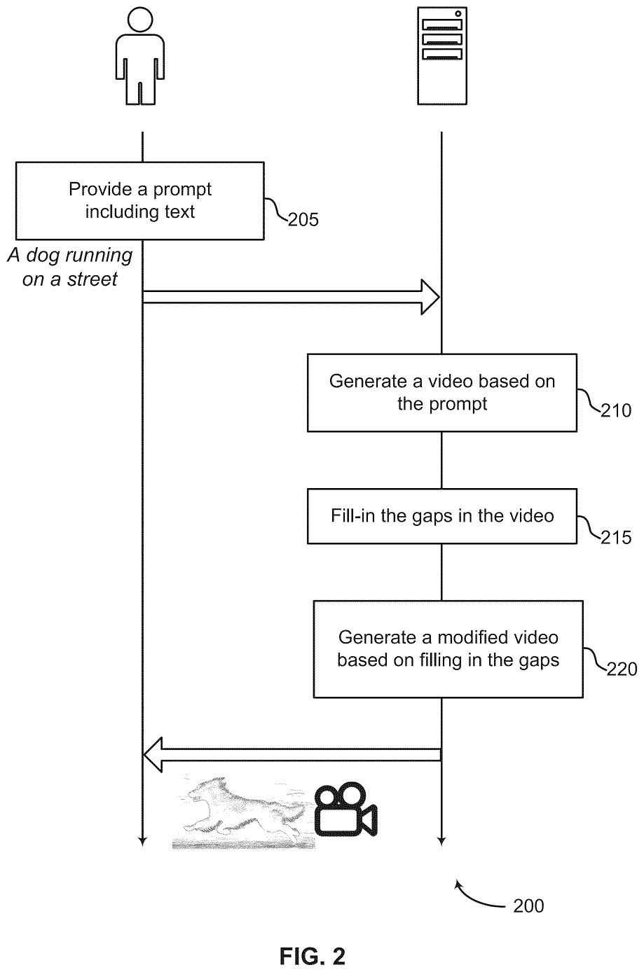

In the example of FIG. 1, user provides a prompt with an action (e.g., running) to video processing apparatus 115 via a user interface provided on user device 110 by video processing apparatus 115. In some examples, the input prompt is an input text (such as shown in FIGS. 1-2). As shown in FIG. 1, the input prompt is a text that provides details on an element and an action (e.g., “a dog running on a street”) based on which the user wants to generate a video using the video processing apparatus 115 of the present disclosure.

In some cases, the video processing apparatus 115 implements a video generation model (such as the video generation model described with reference to at least FIGS. 4-9) to generate a video that is based on the input prompt. In some cases, as shown in FIG. 1, the user provides an input prompt (e.g., a text query) to the video processing apparatus 115, aspects of which the user wants to depict in the video. In some examples, the video processing apparatus generates a video that accurately aligns with the information provided by the input prompt.

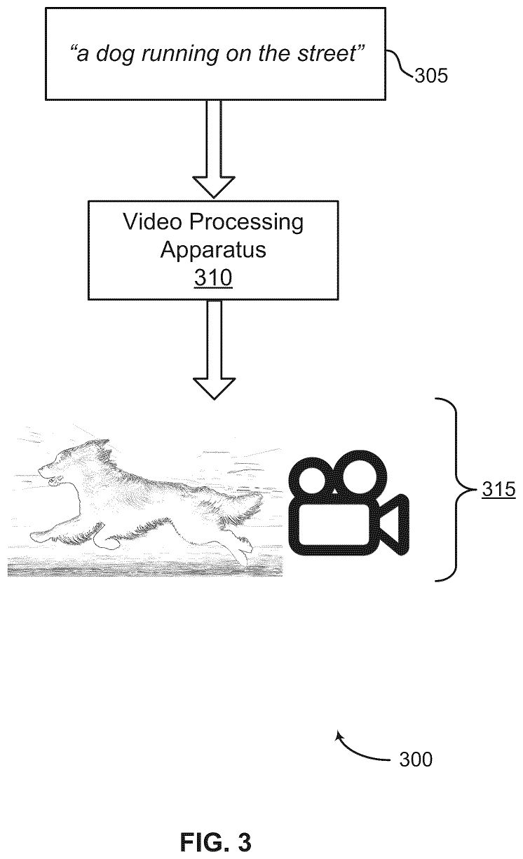

In some cases, the user provides an input query (e.g., an input video containing flickering artifacts) to the video processing apparatus 115, which the user wants to modify in the generated video. In some examples, the video processing apparatus generates the video that accurately prevents occurrence of flickering artifacts and ensure temporal consistency. Video processing apparatus 115 is an example of, or includes aspects of, the corresponding element described with reference to FIG. 3.

Referring again to the example of FIG. 1, the video processing apparatus 115 generates the video that accurately depicts (or modifies) an aspect (e.g., element) described by the input prompt. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by video processing apparatus 115. In some aspects, the user interface provides for information (such as videos (an input video or a generated video), images, a prompt, a canvas, etc.) to be communicated between user 105 and video processing apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

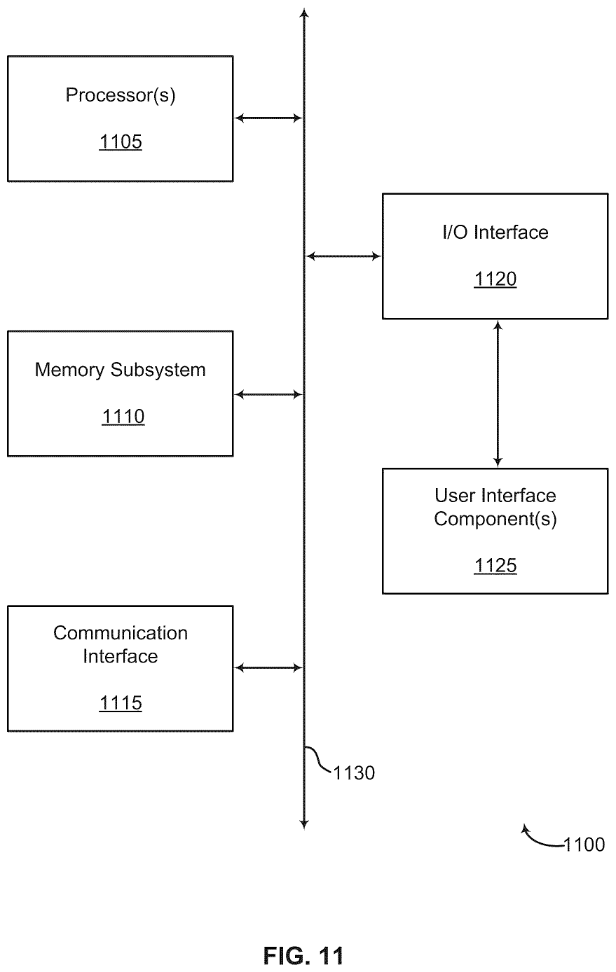

According to some aspects, video processing apparatus 115 includes a computer-implemented network. In some embodiments, the computer-implemented network includes a video generation model (such as the video generation model described with reference to at least FIGS. 4-9). In some embodiments, video processing apparatus 115 also includes one or more processors, a memory subsystem, a communication interface, an I/O interface, one or more user interface components, and a bus as described with reference to FIG. 11. Additionally, in some embodiments, video processing apparatus 115 communicates with user device 110 and database 125 via cloud 120.

In some cases, video processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, video processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to video processing apparatus 115 and communicates with video processing apparatus 115 via cloud 120. According to some aspects, database 125 is included in video processing apparatus 115.

FIG. 2 shows an example of a method 200 for video generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

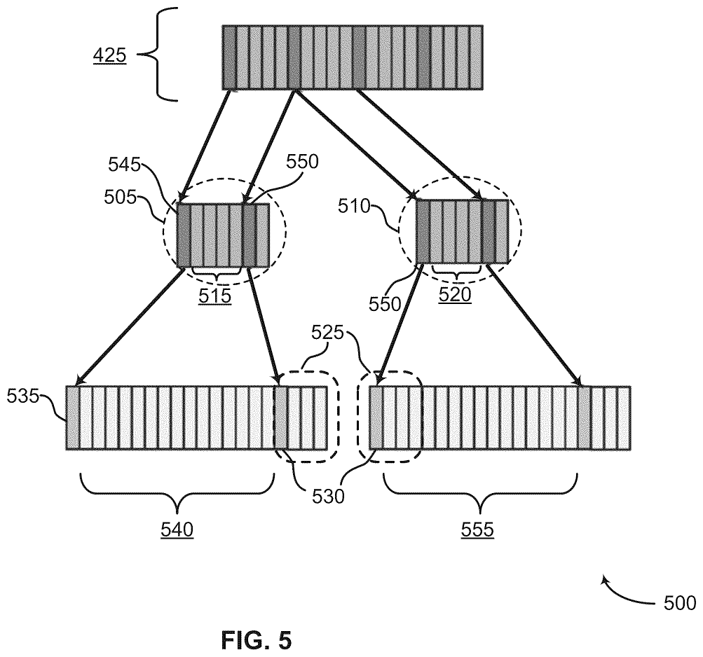

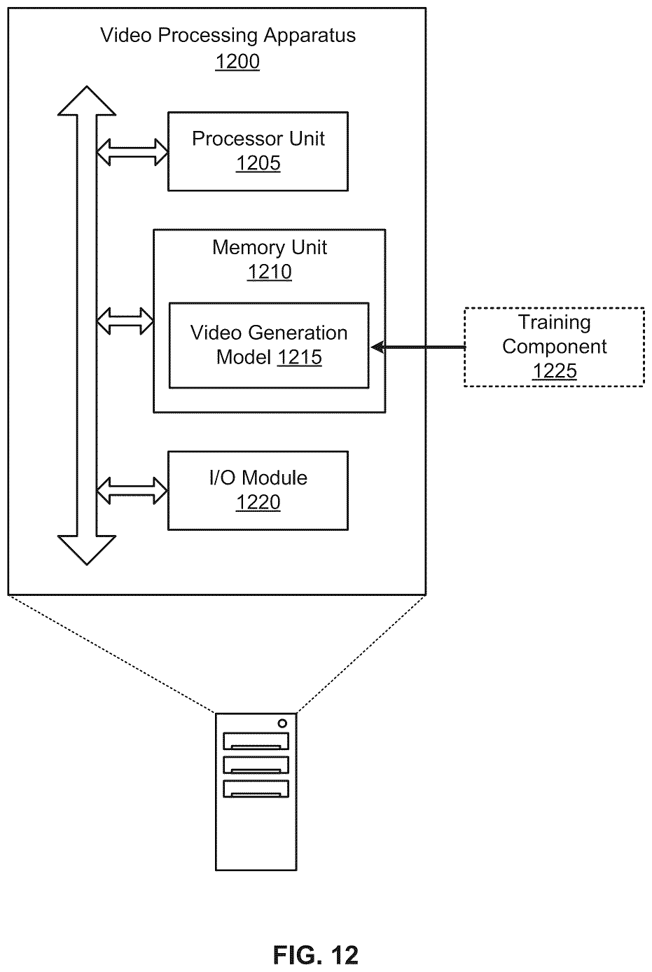

According to an embodiment of the present disclosure, a video processing apparatus (such as the video processing apparatus described with reference to FIGS. 3 and 12) provides a video generation model (such as the video generation model described with reference to FIGS. 4-5) that accurately generates a video depicting an action performed by the element described in the input query.

At operation 205, the system provides a prompt including text. In some cases, the operations of this step refer to, or may be performed by, a user as described with reference to FIG. 1. In some cases, the text prompt provides an object based on which the user wants to generate a video. Additionally or alternatively, the text prompt provides an action based on which the user wants to generate a video. For example, the user provides a text prompt instructing the video processing apparatus to generate a video that accurately aligns with the text prompt.

At operation 210, the system generates a video based on the prompt. In some cases, the operations of this step refer to, or may be performed by, a video processing apparatus as described with reference to FIGS. 1 and 3.

In some cases, the video processing apparatus includes a video generation model comprising a diffusion network (such as the diffusion network described with reference to FIGS. 4-5) that generates a video. In some cases, the video generation model generates the video depicting the object described in the text prompt. In some cases, the video generation model generates the video depicting the action described in the text prompt.

At operation 215, the system fills-in the gaps in the video. In some cases, the operations of this step refer to, or may be performed by, a video processing apparatus as described with reference to FIGS. 1 and 3.

According to an embodiment of the present disclosure, the video generation model divides the video into a plurality of video segments. In some cases, the video generation model performs an interpolation-based decoding on one or more key frames of the video segment. In some examples, the video generation model generates an intermediate video frame based on the key frames associated with the video segment. In some examples, the video generation model uses dual key frames among the plurality of key frames associated with the video segment to generate interpolated video frames resulting in a coherent and artifact-free video generation.

In some cases, the video generation model performs the interpolation of one or more key frames corresponding to a video segment to generate interpolated frames. In some examples, the interpolated frames fill in the motion gaps between the key frames of the video segment. By using a dual key frame method for performing the interpolation to generate an artifact-free video, the video generation model is able to maintain temporal coherence across the plurality of video segments.

At operation 220, the system generates a modified video based on filling in the gaps. In some cases, the operations of this step refer to, or may be performed by, a video processing apparatus as described with reference to FIGS. 1 and 3.

In some cases, the video generation model of the video processing apparatus outputs frames (by combining frames corresponding to the original video generated at operation 210 or a video received from a user or a database via a user interface, and the interpolated frames generated at operation 215) consistent with the text description. The modified video is provided to the user via a user interface of the user device (as described in FIG. 1). Further details regarding the interpolation and generation of the modified video are provided with reference to FIGS. 4 and 6-9.

FIG. 3 shows an example of a video filling process 300 according to aspects of the present disclosure. In one aspect, video filling process 300 includes input prompt 305, video processing apparatus 310, and generated video 315.

In some examples, input prompt 305 describes an element. In some examples, as shown in FIG. 3, input prompt 305 describes an action performed by an element. In some examples, the user provides input prompt 305 to video processing apparatus 310 via a user interface of the video processing apparatus 310. Input prompt 305 is an example of, or includes aspects of, the corresponding element described with reference to FIGS. 1-2.

The video processing apparatus 310 (such as the video processing apparatus described with reference to at least FIGS. 1-2 and 12) of the present disclosure receives the input prompt 305 from the user. In some cases, the video processing apparatus 310 comprises a video generation model including a video-based diffusion network (such as the diffusion network described with reference to FIGS. 4-5) and a transformer model that generate a video based on an interpolation method. In some examples, the video generation model comprises a video decoder that performs an interpolation-based decoding to generate an artifact-free video 315.

In some cases, the video processing apparatus 310 divides a video (such as video generated at operation 210 described with reference to FIG. 2) into a plurality of video segments. In some cases, the video processing apparatus 310 generates an interpolated video frame based on interpolating the key frames associated with the video segment. In some examples, the interpolated video frame fills in the motion gaps between the key frames of the video segment. Video processing apparatus 310 is an example of, or includes aspects of, the corresponding element described with reference to FIG. 1. Video 315 is an example of, or includes aspects of, the corresponding element described with reference to FIG. 4.

FIG. 4 shows an example of a video processing apparatus according to aspects of the present disclosure. Video processing apparatus 400 is an example of, or includes aspects of, the corresponding element described with reference to FIGS. 1 and 3. In one aspect, video processing apparatus 400 includes training video 405, latent vector 415, plurality of tokens 425, and synthetic video 435. In one aspect, video processing apparatus 400 performs video generation based on variational autoencoder (VAE encoder) 410, diffusion transformer encoder 420, and decoder 430.

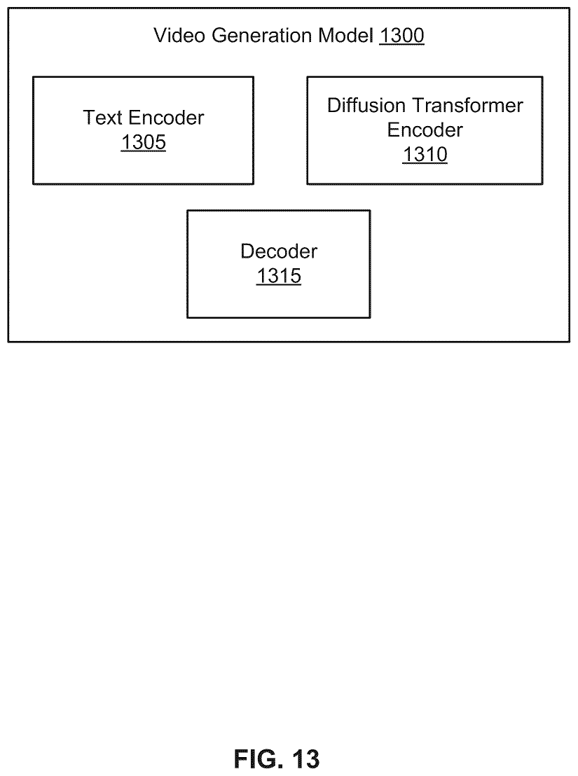

In some examples, a guided diffusion model describes the operation and architecture of the video generation model 1300 described with reference to FIG. 13. Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model may take a training video 405 in a pixel space as input and apply forward diffusion process to gradually add noise to the training video 405 to obtain noisy media item at various noise levels. As shown in FIG. 4, the training video 405 is passed through a VAE (Variational Autoencoder) encoder 410, which compresses the video into a set of latent vectors 415, i.e., lower-dimensional representations of video frames.

The visual patches are then corrupted with noise through a diffusion process, creating diffused visual patches. The diffused visual patches are organized into a latent representation using patching and positional encoding, enabling the system to capture spatial and temporal structure.

Diffusion transformer encoder 420 takes both the latent and the conditional latent and processes them through N layers of transformer blocks. The plurality of tokens 425 generated by the transformer encoder 420 are then passed through a linear layer and reshaped into a structured latent representation.

Next, a reverse diffusion process (e.g., a decoder 430, such as the decoder described in FIG. 5) gradually removes the noise from the noisy media item at the various noise levels to obtain an output media item (e.g., synthetic video 435). In some cases, an output media item 435 is created from each of the various noise levels. The output media item 435 can be compared to the training video 405 to train the reverse diffusion process.

In some cases, the reverse diffusion process can also be guided based on a text prompt, or another guidance prompt, such as an image, a layout, a segmentation map, etc. The text prompt can be encoded using a text encoder (e.g., a multimodal encoder) to obtain guidance features in guidance space. The guidance features can be combined with the noisy media item at one or more layers of the reverse diffusion process to ensure that the output media item includes content described by the text prompt. For example, guidance features can be combined with the noisy features using a cross-attention block within the reverse diffusion process. For instance, reverse diffusion process can be a diffusion transformer network or a U-Net.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item, such as synthetic video 435.

As used herein, the diffusion transformer (DiT) architecture 420 includes predicted noise, predicted covariance, linear and reshape layers, normalization layer, DiT block(s), patchify operation, embedding, noised latent (latent vector 415), timestep information, label information, and an implementation of one block in the DiT block(s) by a DiT Block. The DiT Block includes: second residual connection, second scaling operations, feed-forward network, post-normalization second scaling and shifting, second normalization, first residual connection, first scaling operations, self-attention, post-normalization first scaling and shifting, first normalization, input tokens, conditioning tokens, multi-layer perceptron (MLP), post-normalization first scaling and shifting parameters, first scaling parameter, post-normalization second scaling and shifting parameters, and second scaling parameter. In some embodiments, the architecture employs a Latent Diffusion Transformer. In some embodiments, DiT Block employs an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x [symbol] x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all αs; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The encoder architecture 420, in some cases, employs a Latent Diffusion Transformer. The architecture 420 processes noised latent (latent vector 415), which may be a noised version of a training video 405 encoded in a latent space. Patchify operation divides the noised latent into a sequence of patches that are processed as tokens. The tokens are vector representations of each patch of the image in latent space and are adjusted through attention processes. Each of the tokens also receives timestep information and label information and, accordingly, their embedding, which encodes the current denoising timestep and class labels as conditional information. In some cases, embedding is referred to as conditional embedding or conditional information embedding. In some cases, a positional embedding which encodes each token's spatial position in the image is applied to the patchified input tokens at the patchify operations. In some examples the positional embedding is ViT frequency-based positional embedding. The input tokens generated by the patchify operation and the conditioning tokens generated by the embedding are processed through N DiT block(s), where N may be 12, 24 or 28. Other values of N may be used. In some cases, conditional tokens refer to tokens generated based on embedding encoding timestep information and label information.

Each of the DiT block(s) includes multiple processing stages. DiT Block illustrates an embodiment of one block in the DiT block(s). In some embodiments, the DiT Block is an example of, or includes aspects of, the adaLN-Zero block. In some cases, latent vector 415 interact with the conditioning tokens through multiple attention mechanisms. Particularly, after first normalization applied to the input tokens and MLP to the conditional tokens, MLP generates or updates post-normalization first scaling and shifting parameters, denoted as γ₁, β₁, for post-normalization first scaling and shifting to scale and shift the output of first normalization accordingly. As the normalized input tokens obtained from first normalization are scaled and shifted at post-normalization first scaling and shifting using the conditional information carried as least in γ₁, β₁, this allows the input information and conditional information to interact. Self-attention allows the scaled and shifted normalized input tokens, namely the output from post-normalization first scaling and shifting, to attend to each other. MLP also generates or updates first scaling parameter denoted as α₁ for first scaling operations to scale the output of self-attention (e.g., multi-head self-attention), further interacting the input information and conditional information. The input tokens is then summed with the output of first scaling operations at first residual connection. In some examples, α₁ has initial values 0, and the DiT Block is initialized as the identity function.

A similar process is performed in a second half of the DiT Block. MLP generates or updates post-normalization second scaling and shifting parameters, denoted as γ₂, β₂, for post-normalization second scaling and shifting to scale and shift the output of second normalization accordingly. As the output from second normalization is scaled and shifted using the conditional information carried at least in γ₂, β₂, this allows the input information and conditional information to further interact. Feed-forward network then processes the scaled and shifted output from post-normalization second scaling and shifting. MLP also generates or updates second scaling parameter denoted as α₂ for second scaling operations to scale the output of feed-forward network, further interacting the input information and conditional information. In some cases, the feed-forward network is a pointwise feed-forward network. The output from first residual connection is then summed with the output of second scaling operations at second residual connection, and the result is the final output of DiT Block. In some examples, α₂ has initial values 0, and the DiT Block is initialized as the identity function. This process repeats for each DiT block in the sequence.

After processing through all DiT block(s), the outputs undergo normalization layer followed by linear and reshape layers. The final output is the predicted noise, which represents the model's prediction of the noise that was added to initially create the noised latent, and the predicted covariance, which represents the model's prediction of the covariance. The predicted noise is removed from noised latent at each diffusion timestep, and the predicted covariance may affect how noise is removed or resampled in the reverse or denoising process. At the end of the denoising schedule, the latent sample is decoded to generate the synthetic image in pixel space.

As described herein, using a diffusion model can involve both a forward diffusion process for adding noise to a media item (or features in a latent space) and a reverse diffusion process for denoising the media item (or features) to obtain a denoised media item. The forward diffusion process can be represented as q(xₜ|xₜ₋₁), and the reverse diffusion process can be represented as p(xₜ₋₁|xₜ). In some cases, the forward diffusion process is used during training to generate media items with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x₇, such as a noisy media item and denoises the data to obtain the p(xₜ₋₁|xₜ). At each step t−1, the reverse diffusion process takes xₜ, such as first intermediate media item, and t as input. Here, t represents a step in the sequence of transitions associated with different noise levels, the reverse diffusion process outputs xₜ₋₁, such as second intermediate media item iteratively until x_{T} reverts back to x₀, the original media item. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

VAE encoder 410 is an example of, or includes aspects of, the corresponding element described with reference to FIG. 13. Diffusion transformer encoder 420 is an example of, or includes aspects of, the corresponding element described with reference to FIGS. 5 and 13. Decoder 430 is an example of, or includes aspects of, the corresponding element described with reference to FIGS. 5 and 13. Synthetic video 435 is an example of, or includes aspects of, the corresponding element described with reference to FIG. 3.

FIG. 5 shows an example of a video filling-in process according to aspects of the present disclosure.

In one aspect, video filling-in process 500 includes first frame chunk 505, second frame chunk 510, first set of intermediate frame tokens 515, second set of intermediate frame tokens 520, plurality of overlapping frames 525, overlapping key frame 530.

In one aspect, first frame chunk 505 includes first key frame 535 corresponding to first key frame token 545 and overlapping key frame 530 corresponding to second key frame token 550. Additionally, in one aspect, first frame chunk 505 includes first set of intermediate frames 540 corresponding to first set of intermediate frame tokens 515.

In one aspect, second frame chunk 510 includes overlapping key frame 530 corresponding to second key frame token 550 and a third key frame corresponding to third key frame token. Additionally, in one aspect, second frame chunk 510 includes second set of intermediate frames 555 corresponding to second set of intermediate frame tokens 520.

Embodiments of the present disclosure include a video generation model that generates a video based on an interpolation method. In some cases, video generation model (such as video generation model described with reference to FIGS. 5-9) comprises a video decoder that performs an interpolation-based decoding. The video generation model divides an input video stream (such as video stream 425 described with reference to FIG. 4) into a plurality of video segments, such as a first frame chunk 505 and second frame chunk 510. In some cases, the video decoder uses one or more key frame tokens (e.g., first key frame token 545, second key frame token 550) of each video chunk of the plurality of video chunks.

The present disclosure describes systems and methods for video generation. In some cases, video generation model comprises a video-based diffusion network (as described with reference to FIG. 4). In some cases, video generation model generates a latent representation based on an input video stream (such as input video stream 425). In some cases, video generation model generates a latent representation based on an input prompt.

In some cases, the video decoder takes the latent representation as input and generates a token corresponding to the latent representation. For example, the video decoder generates the set of tokens based on decoding the latent representation. In some examples, video generation model extracts first key frame token 545 and second key frame token 550 from set of tokens. For example, first set of intermediate frame tokens 515 are placed between first key frame token 545 and second key frame token 550 (i.e., the last key frame token of the first set of tokens). For example, second set of intermediate frame tokens 520 are placed between second key frame token 550 and a third key frame token (i.e., the last key frame token of the second set of tokens). As shown in FIG. 5, a correspondence (such as a 1:1 correspondence) exists between the key frames (such as key frame tokens 545, 550 and key frames associated with the set of video frames).

In some cases, video generation model interpolates an intermediate latent frame from the set of intermediate latent frames to generate a new set of frames. As shown in FIG. 5, video generation model generates an intermediate video frame (e.g., first set of intermediate frames 540 and second set of intermediate frames 555) based on the key frames (e.g., first key frame 535 and overlapping key frame 530, and overlapping key frame 530 and a third key frame, respectively) associated with the video segment (such as first frame chunk 505 and second frame chunk 510).

For example, video generation model interpolates first set of intermediate frame tokens 515 from the first frame chunk 505 to generate first set of intermediate frames 540. Additionally, for example, video generation model interpolates second set of intermediate frame tokens 520 from the second frame chunk 510 to generate second set of intermediate frames 555. In some examples, the generated intermediate subset of video frames are used to fill a motion gap between two key frames.

According to an embodiment, the video generation model takes an additional latent representation as input and generates a video frame corresponding to the latent representation. For example, the video generation model takes two additional latent representations associated with a subsequent video segment as input. In some examples, the video generation model interpolates the four overlapping video frames between a previous video segment corresponding to the first set of intermediate frames 540 and the current video segment corresponding to the second set of intermediate frames 555. As shown in FIG. 5, the video generation model generates four overlapping video frames (such as overlapping set of video frames 525) based on the two additional latent representations.

Accordingly, an apparatus for video processing is described. One or more aspects of the apparatus include obtaining an input prompt describing a scene; generating, using a video generation model, a set of frame tokens including a first frame chunk and a second frame chunk based on the input prompt, wherein the first frame chunk includes a first token corresponding to a video frame and the second frame chunk includes a second token corresponding to the same video frame as the first token; and generating, using the video generation model, a synthetic video based on the set of frame tokens including the first frame chunk and the second frame chunk, wherein the synthetic video depicts the scene and includes the video frame.

In some aspects, the video generation model comprises a diffusion transformer encoder configured to generate the first frame chunk and the second frame chunk. In some aspects, the video generation model comprises a decoder configured to decode the first frame chunk and the second frame chunk.

Some examples of the apparatus and system further include generating the synthetic video comprises generating a first intermediate video frame based on the first token and a second intermediate video frame based on the second token; and blending the first intermediate video frame and the second intermediate video frame to obtain the video frame.

Some examples of the apparatus and system further include generating the first frame chunk comprising: initializing a plurality of noise tokens; and denoising the plurality of noise tokens based on the input prompt. In some aspects, the video generation model is trained to generate overlapping frame chunks.

### Video Generation Process

Embodiments of the present disclosure include a video generation model configured to perform an interpolation of a key frame associated with a video segment. In some cases, the video generation model comprises a video decoder that performs a dual key frame sharing. In some cases, a set of last RGB frames of a current video segment are used as the starting RGB frames for a subsequent video segment. By using the last frames of a current video segment as the first token set of a subsequent video segment, embodiments of the present disclosure are able to ensure information continuity across the video segments associated with the input video stream.

Embodiments of the present disclosure include a video generation model configured to perform an interpolation of a key frame associated with a video segment. By implementing the interpolation aware mechanism in the video generation model, embodiments of the present disclosure optimize motion consistency across the video segments associated with the input video stream.

In some cases, the video generation model enables motion consistency by learning to smoothly transition the latent representations across the video segments. Additionally, by implementing the interpolation aware mechanism in the video generation model, embodiments are able to significantly reduce computational resources while eliminating flickering artifacts in the generated video. By implementing task-specific optimization metrics in the video generation model, embodiments of the present disclosure are able to maximize coherence in the generated video.

FIG. 6 shows an example of a method 600 for video processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 605, the system obtains an input prompt describing a scene. In some cases, the operations of this step refer to, or may be performed by, a video processing apparatus as described with reference to FIG. 11.

For example, in some cases, the user interface of the video processing apparatus (such as video processing apparatus 1200 described with reference to FIG. 12) receives an input prompt from a user. In some examples, the input prompt comprises a text prompt that describes an object that the user wants to depict in the generated asset (e.g., video). Additionally or alternatively, for example, the input prompt comprises a text prompt that describes an action performed by an element that the user wants to depict in the generated asset (e.g., video). In some examples, the video processing apparatus receives the input prompt from a database or any other data source.

At operation 610, the system generates a first frame chunk and a second frame chunk based on the input prompt, where the first frame chunk includes a first token corresponding to a video frame and the second frame chunk includes a second token corresponding to the same video frame as the first token. In some cases, the operations of this step refer to, or may be performed by, a video generation model as described with reference to FIG. 12.

The present disclosure describes systems and methods for video generation. Embodiments of the present disclosure include a video generation model comprising a video decoder. In some cases, the video generation model comprises a video-based diffusion network (such as a diffusion network described with reference to FIGS. 4-5). In some cases, the video generation model generates a latent representation based on an input video stream. In some cases, the video generation model generates a latent representation based on an input prompt.

In some cases, the video decoder takes the latent representation as input and generates an RGB frame corresponding to the latent representation. In some examples, the RGB frame is referred to as a pixel frame. For example, the video decoder generates the RGB frame based on decoding the latent representation. In some examples, each video segment comprises 16 RGB frames (i.e., 16 pixel frames).

According to an embodiment of the present disclosure, each pixel frame is defined by two latent key frame tokens (such as first key frame token 545 and second key frame token 550 described with reference to FIG. 5). In some cases, each pixel frame comprises the latent key frames, i.e., a first key frame and a second key frame (associated with first key frame token 545 and second key frame token 550 associated with the first frame chunk). Additionally, each pixel frame comprises a set of intermediate latent frames (such as first set of intermediate frame tokens 515 and second set of intermediate frame tokens 520 described with reference to FIG. 5). For example, the set of intermediate latent frames are placed between the first frame and the last frame.

An embodiment of the present disclosure includes a video generation model comprising a video decoder. In some cases, the video decoder interpolates an intermediate latent frame from the set of intermediate latent frames to generate a new set of frames (such as overlapping set of video frames 525 described with reference to FIG. 5). For example, the new set of frames comprise an intermediate subset of video frames (such as first set of intermediate frames 540 and second set of intermediate frames 555 described with reference to FIG. 5) based on performing the interpolation operation. In some cases, the intermediate subset of video frames are used to fill a motion gap between two key frames. By generating the new set of frames to fill the motion gap between the video segments, embodiments of the present disclosure are able to ensure consistency across the video segments while eliminating flickering artifacts and maintaining computational efficiency.

An embodiment of the present disclosure includes a video generation model comprising a video decoder. In some cases, the video decoder takes an additional latent representation as input and generates an RGB frame corresponding to the latent representation. For example, the video decoder takes two additional latent representations associated with a subsequent video chunk as input. In some examples, the video decoder generates four overlapping RGB frames (such as overlapping set of video frames 530 described with reference to FIG. 5) based on the two additional latent representations.

At operation 615, the system generates a synthetic video based on the set of frame tokens including the first frame chunk and the second frame chunk, where the synthetic video depicts the scene and includes the video frame. In some cases, the operations of this step refer to, or may be performed by, a video generation model as described with reference to FIG. 12.

An embodiment of the present disclosure includes a video generation model that performs a post-processing operation. In some examples, the video generation model interpolates the four overlapping RGB frames between a previous video segment and the current video segment. Accordingly, by performing an interpolation between the previous and the current segment to generate additional RGB frames, embodiments of the present disclosure are able to achieve a smooth transition between each video segment among the plurality of video segments. In some embodiments, the user interface provides the synthetic video to the user via the user interface.

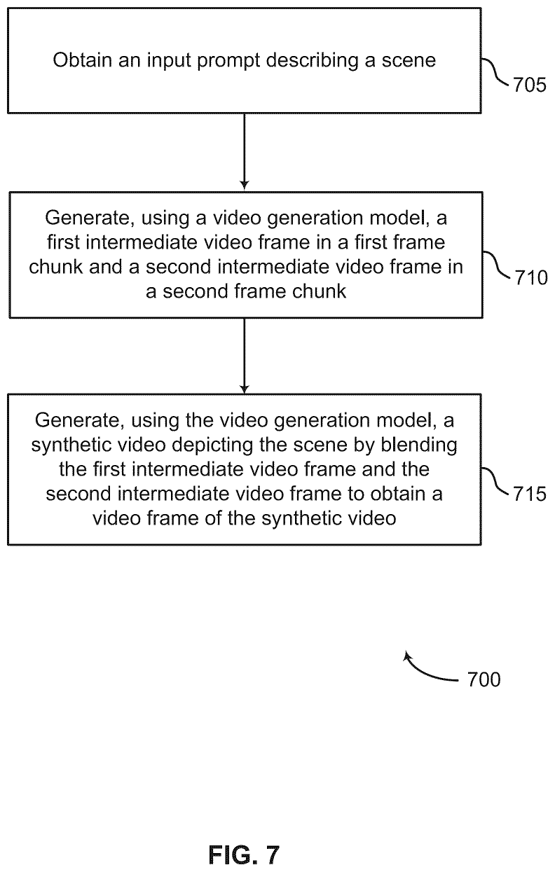

FIG. 7 shows an example of a method 700 for video processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 705, the system obtains an input prompt describing a scene. In some cases, the operations of this step refer to, or may be performed by, a video processing apparatus as described with reference to FIG. 11.

For example, in some cases, the user interface of the video processing apparatus (such as video processing apparatus 1200 described with reference to FIG. 12) receives an input prompt from a user. In some examples, the input prompt comprises a text prompt that describes an object that the user wants to depict in the generated asset (e.g., synthetic video). Additionally or alternatively, for example, the input prompt comprises a text prompt that describes an action performed by an element that the user wants to depict in the generated asset (e.g., synthetic video). In some examples, the video processing apparatus receives the input prompt from a database or any other data source.

At operation 710, the system generates a first intermediate video frame in a first frame chunk and a second intermediate video frame in a second frame chunk. In some cases, the operations of this step refer to, or may be performed by, a video generation model as described with reference to FIG. 12.

According to an embodiment of the present disclosure, a pixel frame of a frame chunk is defined by two latent key frame tokens (such as first key frame token 545 and second key frame token 550 in frame chunk 505 described with reference to FIG. 5). In some cases, each pixel frame comprises the latent key frames, i.e., a first key frame and a second key frame (associated with first key frame token 545 and second key frame token 550 associated with the first frame chunk 505 in FIG. 5). Additionally, each pixel frame comprises a set of intermediate latent frames (such as first set of intermediate frame tokens 515 and second set of intermediate frame tokens 520 described with reference to FIG. 5).

In some cases, a video decoder of the video generation model interpolates an intermediate latent frame from the set of intermediate latent frames to generate a new set of frames (such as set of overlapping video frames 525 described with reference to FIG. 5). For example, the new set of frames comprise an intermediate subset of video frames (such as first set of intermediate frames 540 and second set of intermediate frames 555 described with reference to FIG. 5) based on performing the interpolation operation. In some cases, the intermediate subset of video frames are used to fill a motion gap between two key frames.

In some cases, the video decoder takes an additional latent representation as input and generates an RGB frame corresponding to the latent representation. In some examples, the video decoder generates four overlapping RGB frames (such as overlapping set of video frames 525 described with reference to FIG. 5) based on the two additional latent representations.

At operation 715, the system generates a synthetic video depicting the scene by blending the first intermediate video frame and the second intermediate video frame to obtain a video frame of the synthetic video. In some cases, the operations of this step refer to, or may be performed by, a video generation model as described with reference to FIG. 12.

An embodiment of the present disclosure includes a video generation model that performs a post-processing operation. In some examples, the video generation model interpolates the four overlapping RGB frames between a previous video segment and the current video segment (as indicated by the overlapping frames 525 in FIG. 5). In some examples, the blending of the previous video segment and the current video segment is performed based on a ratio. For example, the blending is performed in ratios of 0%, 25%, 50%, and 75%.

Accordingly, by performing an interpolation between the previous segment and the current segment to generate additional RGB frames, embodiments of the present disclosure are able to achieve a smooth transition between each video segment among the plurality of video segments. In some embodiments, the user interface provides the synthetic video to the user via the user interface.

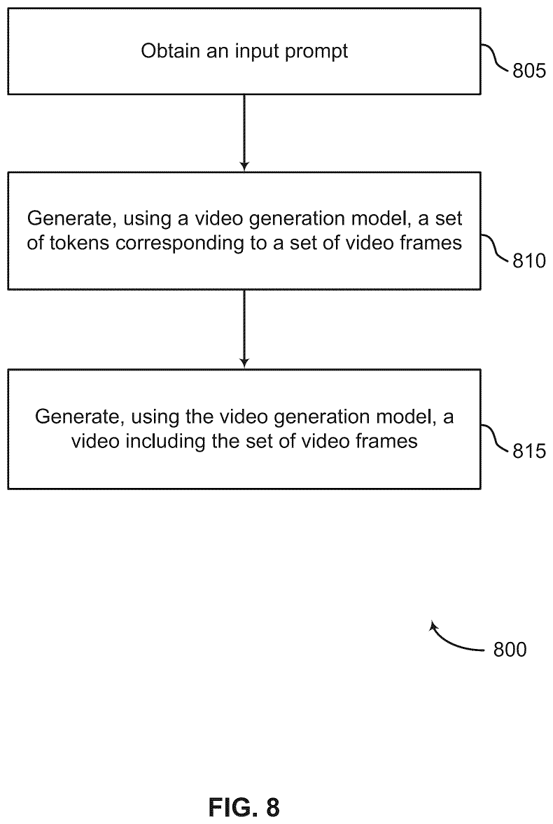

FIG. 8 shows an example of a method 800 for video processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains an input prompt. In some cases, the operations of this step refer to, or may be performed by, a user interface as described with reference to FIG. 1.

For example, in some cases, the user interface of the video processing apparatus (such as video processing apparatus 1200 described with reference to FIG. 12) receives an input prompt from a user. In some examples, the input prompt comprises a text prompt that describes an object that the user wants to depict in the generated asset (e.g., synthetic video). Additionally or alternatively, for example, the input prompt comprises a text prompt that describes an action performed by an element that the user wants to depict in the generated asset (e.g., synthetic video). In some examples, the video processing apparatus receives the input prompt from a database or any other data source.

At operation 810, the system generates a set of tokens corresponding to a set of video frames. In some cases, the set of tokens includes a first key frame token, a second key frame token, a first set of intermediate tokens corresponding to the first key frame token, and a second set of intermediate tokens corresponding to the second key frame token. In some cases, the operations of this step refer to, or may be performed by, a video generation model as described with reference to FIGS. 4-5.

The present disclosure describes systems and methods for video generation. Embodiments of the present disclosure include a video generation model comprising a video decoder. In some cases, the video generation model comprises a video-based diffusion network (such as a diffusion network described with reference to FIGS. 4-5). In some cases, the video generation model generates a latent representation based on an input video stream. In some cases, the video generation model generates a latent representation based on an input prompt.

In some cases, the video decoder takes the latent representation as input and generates an RGB frame corresponding to the latent representation. In some examples, the RGB frame is referred to as a pixel frame. For example, the video decoder generates the RGB frame based on decoding the latent representation. In some examples, each video segment comprises 16 RGB frames. That is, in some examples, each video segment comprises 16 pixel frames.

According to an embodiment of the present disclosure, each pixel frame is defined by two latent key frame tokens (such as first key frame token 545 and second key frame token 550 described with reference to FIG. 5). In some cases, each pixel frame comprises the latent key frames, i.e., a first frame and a last frame (such as first key frame token 545 and second key frame token 550 associated with the first set of tokens). Additionally, each pixel frame comprises a set of intermediate latent frames (such as first set of intermediate frame tokens 515 and second set of intermediate frame tokens 520 described with reference to FIG. 5). For example, the set of intermediate latent frames are placed between the first key frame and a subsequent key frame of a frame chunk.

An embodiment of the present disclosure includes a video generation model comprising a video decoder. In some cases, the video decoder interpolates an intermediate latent frame from the set of intermediate latent frames to generate a new set of frames (such as overlapping set of video frames 525 described with reference to FIG. 5). For example, the new set of frames comprise an intermediate subset of video frames (such as first set of intermediate frames 540 and second set of intermediate frames 555 described with reference to FIG. 5) based on performing the interpolation operation. In some cases, the intermediate subset of video frames are used to fill a motion gap between two key frames. By generating the new set of frames to fill the motion gap between the video segments, embodiments of the present disclosure are able to ensure consistency across the video segments while eliminating flickering artifacts and maintaining computational efficiency.

An embodiment of the present disclosure includes a video generation model comprising a video decoder. In some cases, the video decoder takes an additional latent representation as input and generates an RGB frame corresponding to the latent representation. For example, the video decoder takes two additional latent representations associated with a subsequent video chunk as input. In some examples, the video decoder generates four overlapping RGB frames (such as overlapping set of video frames 525 described with reference to FIG. 5) based on the two additional latent representations.

At operation 815, the system generates a video including the set of video frames, where a first subset of video frames from the set of video frames is generated based on the first key frame token, the first set of intermediate tokens, and the second key frame token, and where a second subset of video frames from the set of video frames is generated based on the second key frame token and the second set of intermediate tokens. In some cases, the operations of this step refer to, or may be performed by, a video generation model as described with reference to FIGS. 4-9.

An embodiment of the present disclosure includes a video generation model that performs a post-processing operation. In some examples, the video generation model interpolates the four overlapping RGB frames between a previous video segment and the current video segment. Accordingly, by performing an interpolation between the previous and the current segment to generate additional RGB frames, embodiments of the present disclosure are able to achieve a smooth transition between each video segment among the plurality of video segments. In some embodiments, the user interface provides the video to the user via the user interface.

Accordingly, a method for video processing is described. One or more aspects of the method include obtaining an input prompt describing a scene; generating, using a video generation model, a set of frame tokens including a first frame chunk and a second frame chunk based on the input prompt, wherein the first frame chunk includes a first token corresponding to a video frame and the second frame chunk includes a second token corresponding to the same video frame as the first token; and generating, using the video generation model, a synthetic video based on the set of frame tokens including the first frame chunk and the second frame chunk, wherein the synthetic video depicts the scene and includes the video frame.

In some aspects, the first frame chunk and the second frame chunk each include a plurality of overlapping tokens including an overlapping key frame token. In some aspects, the first frame chunk includes a first key frame, a first set of intermediate frames associated with the first key frame, a second key frame, and a second subset of intermediate frames from a second set of intermediate frames associated with the second key frame; and the second frame chunk includes the second key frame, the second set of intermediate frames associated with the second key frame, a subsequent key frame, and a subsequent subset of intermediate frames associated with the subsequent key frame.

Some examples of the method, apparatus, and non-transitory computer readable medium further include generating the synthetic video comprises generating a first intermediate video frame based on the first token and a second intermediate video frame based on the second token; and blending the first intermediate video frame and the second intermediate video frame to obtain the video frame. In some aspects, the blending comprises: performing an interpolation between the first intermediate video frame and the second intermediate video frame in a pixel space.

Some examples of the method, apparatus, and non-transitory computer readable medium further include generating the first frame chunk comprises: initializing a plurality of noise tokens; and denoising the plurality of noise tokens based on the input prompt. In some aspects, the video generation model is trained to generate overlapping frame chunks.

Additionally, a method for video processing is described. One or more aspects of the method include obtaining an input prompt describing a scene; generating, using a video generation model, a first intermediate video frame in a first frame chunk and a second intermediate video frame in a second frame chunk; and generating, using the video generation model, a synthetic video depicting the scene by blending the first intermediate video frame and the second intermediate video frame to obtain a video frame of the synthetic video.

Some examples of the method, apparatus, and non-transitory computer readable medium further include generating, using the video generation model, the first frame chunk and the second frame chunk based on the input prompt, wherein the first frame chunk includes a first token corresponding to the video frame and the second frame chunk includes a second token corresponding to the same video frame as the first token.

Some examples of the method, apparatus, and non-transitory computer readable medium further include generating the first frame chunk comprising: initializing a plurality of noise tokens; and denoising the plurality of noise tokens based on the input prompt. In some aspects, the first frame chunk and the second frame chunk each include a plurality of overlapping tokens including an overlapping key frame token.

In some aspects, the first frame chunk includes a first key frame, a first set of intermediate frames associated with the first key frame, a second key frame, and a second subset of intermediate frames from a second set of intermediate frames associated with the second key frame; and the second frame chunk includes the second key frame, the second set of intermediate frames associated with the second key frame, a subsequent key frame, and a subsequent subset of intermediate frames associated with the subsequent key frame.

Some examples of the method, apparatus, and non-transitory computer readable medium further include generating the synthetic video comprises performing an interpolation between the first intermediate video frame and the second intermediate video frame in a pixel space. In some aspects, the video generation model is trained to generate overlapping frame chunks.

Accordingly, a method for video processing is described. One or more aspects of the method include obtaining an input prompt; generating, using a video generation model, a set of tokens corresponding to a set of video frames, wherein the set of tokens comprises a first key frame token, a second key frame token, a first set of intermediate tokens corresponding to the first key frame token, and a second set of intermediate tokens corresponding to the second key frame token; and generating, using the video generation model, a video comprising the set of video frames, wherein a first subset of video frames from the set of video frames is generated based on the first key frame token, the first set of intermediate tokens, and the second key frame token, and wherein a second subset of video frames from the set of video frames is generated based on the second key frame token and the second set of intermediate tokens.

In some aspects, the first subset of video frames and the second subset of video frames both include an overlapping set of video frames corresponding to the second key frame token.

### Training the System

FIG. 9 shows an example of a method of training a machine learning model according to aspects of the present disclosure. FIG. 9 is a flow diagram depicting an algorithm as a step-by-step procedure 900 in an example implementation of operations performable for training a machine-learning model. In some embodiments, the procedure 900 describes an operation of the training component 1225 described for configuring the video generation model 1215 as described with reference to FIG. 12. The procedure 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 904) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 906). Initialization of the machine-learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine-learning model (i.e., predictions) and target values (e.g., as expressed by the training data) to be used to train the machine-learning model. Additionally, an optimization algorithm is selected (912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 900 continues training of the machine-learning model using the training data (block 918) in this example.

If the stopping criterion is met (“yes” from decision block 920), the trained machine-learning model is then utilized to generate an output based on subsequent data (block 922). The trained machine-learning model, for instance, is trained to perform a task as described above and therefore, once trained is configured to perform that task based on subsequent data received as an input and processed by the machine-learning model.

FIG. 10 shows an example of a method of training a diffusion model 1000 according to aspects of the present disclosure. In some embodiments, the method 1000 describes an operation of the training component 1225 described for configuring the video generation model 1215 as described with reference to FIG. 12. The method 1000 represents an example for training a reverse diffusion process as described above with reference to FIGS. 4-5. In some examples, these operations are performed by a system including a processor executing a set of codes to control functional elements of an apparatus, such as the guided diffusion model described in FIG. 5.

Additionally or alternatively, certain processes of method 1000 may be performed using special-purpose hardware. Generally, these operations are performed according to the methods and processes described in accordance with aspects of the present disclosure. In some cases, the operations described herein are composed of various substeps or are performed in conjunction with other operations.

Referring to FIG. 10, according to some aspects, a training component (such as the training component 1225 described with reference to FIG. 12) trains a diffusion model (such as the video generation model described with reference to FIGS. 4-5) to generate an output.

At operation 1005, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1010, the system adds noise to a training image (or an additional training image) using a forward diffusion process (such as the forward diffusion process described with reference to FIG. 4) in N stages. In some cases, the operations of this step refer to, or may be performed by, a training component as described with reference to FIG. 12.

At operation 1015, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1020, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1025, the system updates parameters of the model based on the comparison. For example, parameters of a U-Net may be updated using gradient descent. Time-dependent parameters of the Gaussian transitions can also be learned.

### Computing Device

FIG. 11 shows an example of a computing device according to aspects of the present disclosure. The computing device 1100 may be an example of the video processing apparatus 1200 described with reference to FIG. 12. In one aspect, computing device 1100 includes processor(s) 1105, memory subsystem 1110, communication interface 1115, I/O interface 1120, user interface component(s) 1125, and channel 1130.

In some embodiments, computing device 1100 is an example of, or includes aspects of, the video generation model of FIG. 12. In some embodiments, computing device 1100 includes one or more processors 1105 that can execute instructions stored in memory subsystem 1110 to perform media generation.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 include a GUI.

FIG. 12 shows an example of a video processing apparatus according to aspects of the present disclosure. Video processing apparatus 1200 is an example of, or includes aspects of, the corresponding element described with reference to FIGS. 1 and 3. According to some aspects, video processing apparatus 1200 obtains an input prompt describing a scene.

In one aspect, video processing apparatus 1200 includes processor unit 1205, memory unit 1210, I/O module 1220, and training component 1225. In one aspect, memory unit 1210 includes video generation model 1215. Training component 1225 updates parameters of the video generation model 1215 stored in memory unit 1210. In some examples, the training component 1225 is located outside the video processing apparatus 1200.

According to some aspects, processor unit 1205 comprises a processing device coupled to the memory component. Processor unit 1205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1205 is configured to operate a memory array using a memory controller. In other cases, a memory controller is integrated into processor unit 1205. In some cases, processor unit 1205 is configured to execute computer-readable instructions stored in memory unit 1210 to perform various functions. In some aspects, processor unit 1205 includes special purpose components for modem processing, baseband processing, digital signal processing, or transmission processing. According to some aspects, processor unit 1205 comprises one or more processors described with reference to FIG. 11.

Memory unit 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1205 to perform various functions described herein.

In some cases, memory unit 1210 includes a basic input/output system (BIOS) that controls basic hardware or software operations, such as an interaction with peripheral components or devices. In some cases, memory unit 1210 includes a memory controller that operates memory cells of memory unit 1210. For example, the memory controller may include a row decoder, column decoder, or both. In some cases, memory cells within memory unit 1210 store information in the form of a logical state. According to some aspects, memory unit 1210 is an example of the memory subsystem 1110 described with reference to FIG. 11.

According to some aspects, video processing apparatus 1200 uses one or more processors of processor unit 1205 to execute instructions stored in memory unit 1210 to perform functions described herein. For example, the video processing apparatus 1200 may obtain an input prompt describing a scene; generate, using a video generation model, a set of frame tokens including a first frame chunk and a second frame chunk based on the input prompt, wherein the first frame chunk includes a first token corresponding to a video frame and the second frame chunk includes a second token corresponding to the same video frame as the first token; and generate, using the video generation model, a synthetic video based on the set of frame tokens including the first frame chunk and the second frame chunk, wherein the synthetic video depicts the scene and includes the video frame.

In one aspect, memory unit 1210 includes video generation model 1215 trained to obtain an input prompt describing a scene; generate, using a video generation model, a set of frame tokens including a first frame chunk and a second frame chunk based on the input prompt, wherein the first frame chunk includes a first token corresponding to a video frame and the second frame chunk includes a second token corresponding to the same video frame as the first token; and generate, using the video generation model, a synthetic video based on the set of frame tokens including the first frame chunk and the second frame chunk, wherein the synthetic video depicts the scene and includes the video frame.

For example, after training, the video generation model 1215 may perform inferencing operations as described with reference to FIGS. 1-3 to obtain an input prompt describing a scene; generate, using a video generation model, a set of frame tokens including a first frame chunk and a second frame chunk based on the input prompt, wherein the first frame chunk includes a first token corresponding to a video frame and the second frame chunk includes a second token corresponding to the same video frame as the first token; and generate, using the video generation model, a synthetic video based on the set of frame tokens including the first frame chunk and the second frame chunk, wherein the synthetic video depicts the scene and includes the video frame.

In some embodiments, the video generation model 1215 is an Artificial neural network (ANN) comprising a plurality of networks including the guided diffusion model described with reference to FIG. 4. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of video generation model 1215 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1225 may train the video generation model 1215. For example, parameters of the video generation model 1215 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 11). The goal of the training process may be to find optimal values for the parameters that allow the video generation model 1215 to make accurate predictions or perform well on the given task.

Additionally, in some aspects, training component 1225 tunes video generation model 1215 by updating one or more temporal layers. In some cases, the temporal layers generate latent embeddings that are influential on the motion features of the generated synthetic video. In at least one embodiment, training component 1225 is implemented on an apparatus different from video processing apparatus 1200.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the video generation model 1215 can be used to make predictions on new, unseen data (i.e., during inference).

According to some aspects, video generation model 1215 generates a set of tokens corresponding to a set of video frames, where the set of tokens includes a first key frame token, a second key frame token, a first set of intermediate tokens corresponding to the first key frame token, and a second set of intermediate tokens corresponding to the second key frame token. In some examples, video generation model 1215 generates a video including the set of video frames, where a first subset of video frames from the set of video frames is generated based on the first key frame token, the first set of intermediate tokens, and the second key frame token, and where a second subset of video frames from the set of video frames is generated based on the second key frame token and the second set of intermediate tokens.

In some aspects, the first subset of video frames and the second subset of video frames both include an overlapping set of video frames corresponding to the second key frame token. In some examples, video generation model 1215 generates the video including: generating a first intermediate subset of video frames corresponding to the first subset of video frames, where the first intermediate subset of video frames includes a first intermediate overlapping set of video frames corresponding to the overlapping set of video frames; generating a second intermediate subset of video frames corresponding to the second subset of video frames, where the second intermediate subset of video frames includes a second intermediate overlapping set of video frames different from the first intermediate overlapping subset of video frames and corresponding to the overlapping set of video frames; and interpolating based on the first intermediate overlapping set of video frames and the second intermediate overlapping set of video frames to obtain the overlapping set of video frames.

In some aspects, the first subset of video frames is generated based on an intermediate token from the second set of intermediate tokens. In some aspects, the first subset of video frames includes a first key frame corresponding to the first key frame token, a second key frame corresponding to the second key frame token, and a first set of intermediate frames between the first key frame and the second key frame, where a number of the first set of intermediate frames is greater than a number of the first set of intermediate tokens. In some examples, video generation model 1215 generates the video including: performing a diffusion process based on the set of tokens. In some aspects, each of the set of video frames includes an image including a set of channels corresponding to a set of colors.

I/O module 1220 receives inputs from and transmits outputs of the video processing apparatus 1200 to other devices or users. For example, I/O module 1220 receives inputs for the video generation model 1215 and transmits outputs of the video generation model 1215. According to some aspects, I/O module 1220 is an example of the I/O interface 1120 described with reference to FIG. 11.

FIG. 13 shows an example of a video generation model 1300 according to aspects of the present disclosure. In one aspect, video generation model 1300 includes text encoder 1305, diffusion transformer encoder 1310, and decoder 1315. According to some aspects, video generation model 1300 is an example of the corresponding element described with reference to FIG. 12.

According to some aspects, video generation model 1300 generates a first frame chunk and a second frame chunk based on the input prompt, where the first frame chunk includes a first token corresponding to a video frame and the second frame chunk includes a second token corresponding to the same video frame as the first token. In some examples, video generation model 1300 generates a synthetic video based on the set of frame tokens including the first frame chunk and the second frame chunk, where the synthetic video depicts the scene and includes the video frame. In some aspects, the first frame chunk and the second frame chunk each include a set of overlapping tokens comprising an overlapping key frame token. In some examples, video generation model 1300 generates the synthetic video including: generating a first intermediate video frame based on the first token and a second intermediate video frame based on the second token; and blending the first intermediate video frame and the second intermediate video frame to obtain the video frame.

According to some aspects, video generation model 1300 generates a first intermediate video frame in a first frame chunk and a second intermediate video frame in a second frame chunk. In some examples, video generation model 1300 generates a synthetic video depicting the scene by blending the first intermediate video frame and the second intermediate video frame to obtain a video frame of the synthetic video. In some examples, video generation model 1300 generates the first frame chunk and the second frame chunk based on the input prompt, where the first frame chunk includes a first token corresponding to the video frame and the second frame chunk includes a second token corresponding to the same video frame as the first token. In some aspects, the first frame chunk and the second frame chunk each include a set of overlapping tokens including an overlapping key frame token. In some examples, video generation model 1300 generates the synthetic video including: performing an interpolation between the first intermediate video frame and the second intermediate video frame in a pixel space.

According to some aspects, video generation model 1300 generates a first frame chunk and a second frame chunk based on the input prompt, wherein the first frame chunk includes a first token corresponding to a video frame and the second frame chunk includes a second token corresponding to the same video frame as the first token. In some examples, video generation model 1300 generates a synthetic video based on the set of frame tokens including the first frame chunk and the second frame chunk, wherein the synthetic video depicts the scene and includes the video frame.

In some examples, video generation model 1300 comprises generating the synthetic video including: generating a first intermediate video frame based on the first token and a second intermediate video frame based on the second token; and blending the first intermediate video frame and the second intermediate video frame to obtain the video frame.

In some aspects, the first frame chunk includes a first key frame, a first set of intermediate frames associated with the first key frame, a second key frame, and a second subset of intermediate frames from a second set of intermediate frames associated with the second key frame; and the second frame chunk includes the second key frame, the second set of intermediate frames associated with the second key frame, a subsequent key frame, and a subsequent subset of intermediate frames associated with the subsequent key frame.

Video generation model 1300 is configured to generate synthetic videos. Embodiments of video generation model 1300 include an image generation model such as a diffusion model that has been adapted to generate temporally coherent frames in a sequence. For example, the video generation model 1300 may include a diffusion model with additional temporal layers.

According to some aspects, text encoder 1305 is configured to process a text input and convert it into a structured numerical representation suitable for downstream processing by one or more machine learning models. The text encoder 1305 may comprise a series of tokenization, embedding, and transformation steps, wherein the input text is first segmented into smaller units (e.g., words, subwords, or characters), each of which is then mapped to a corresponding embedding vector in a high-dimensional space. The embeddings may be further processed using neural network components such as recurrent layers, convolutional layers, or transformer-based architectures to capture semantic, syntactic, and contextual features of the input text. The output of text encoder 1305 is a fixed-length or variable-length representation-referred to as a text embedding—that captures meaningful characteristics of the original input and enables alignment with other modalities, such as images or video, in a multimodal system. The encoder 1305 may be pre-trained or fine-tuned on domain-specific corpora to improve task performance and generalization.

In some aspects, the video generation model 1300 includes a diffusion transformer encoder 1310 configured to generate the first frame chunk and the second frame chunk. According to some aspects, diffusion transformer encoder 1310 generates the first frame chunk including: initializing a set of noise tokens; and denoising the set of noise tokens based on the input prompt. In some aspects, the first frame chunk includes a first key frame, a first set of intermediate frames associated with the first key frame, a second key frame, and a second subset of intermediate frames from a second set of intermediate frames associated with the second key frame; and the second frame chunk includes the second key frame, the second set of intermediate frames associated with the second key frame, a subsequent key frame, and a subsequent subset of intermediate frames associated with the subsequent key frame.

According to some aspects, the video generation model 1300 includes diffusion transformer encoder 1310 comprising generating the first frame chunk including: initializing a set of noise tokens; and denoising the set of noise tokens based on the input prompt.

In some aspects, the video generation model 1300 includes a decoder 1315 configured to decode the first frame chunk and the second frame chunk. In some aspects, the blending includes performing an interpolation between the first intermediate video frame and the second intermediate video frame in a pixel space.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt describing a scene;
generating, using a video generation model, a set of frame tokens including a first frame chunk and a second frame chunk based on the input prompt, wherein the first frame chunk includes a first token corresponding to a video frame and the second frame chunk includes a second token corresponding to the same video frame as the first token; and
generating, using the video generation model, a synthetic video based on the set of frame tokens including the first frame chunk and the second frame chunk, wherein the synthetic video depicts the scene and includes the video frame.

2. The method of claim 1, wherein:
the first frame chunk and the second frame chunk each include a plurality of overlapping tokens including an overlapping key frame token.

3. The method of claim 1, wherein:
the first frame chunk includes a first key frame, a first set of intermediate frames associated with the first key frame, a second key frame, and a second subset of intermediate frames from a second set of intermediate frames associated with the second key frame; and
the second frame chunk includes the second key frame, the second set of intermediate frames associated with the second key frame, a subsequent key frame, and a subsequent subset of intermediate frames associated with the subsequent key frame.

4. The method of claim 1, wherein generating the synthetic video comprises:
generating a first intermediate video frame based on the first token and a second intermediate video frame based on the second token; and
blending the first intermediate video frame and the second intermediate video frame to obtain the video frame.

5. The method of claim 4, wherein the blending comprises:
performing an interpolation between the first intermediate video frame and the second intermediate video frame in a pixel space.

6. The method of claim 1, wherein generating the first frame chunk comprises:
initializing a plurality of noise tokens; and
denoising the plurality of noise tokens based on the input prompt.

7. The method of claim 1, wherein:
the video generation model is trained to generate overlapping frame chunks.

8. A non-transitory computer readable medium storing code for video processing, the code comprising instructions that, when executed by at least one processor, cause the at least one processor to perform operations comprising:
obtaining an input prompt describing a scene;
generating, using a video generation model, a first intermediate video frame in a first frame chunk and a second intermediate video frame in a second frame chunk; and
generating, using the video generation model, a synthetic video depicting the scene by blending the first intermediate video frame and the second intermediate video frame to obtain a video frame of the synthetic video.

9. The non-transitory computer readable medium of claim 8, the code further comprising instructions that, when executed by the at least one processor, cause the at least one processor to perform operations comprising:
generating, using the video generation model, the first frame chunk and the second frame chunk based on the input prompt, wherein the first frame chunk includes a first token corresponding to the video frame and the second frame chunk includes a second token corresponding to the same video frame as the first token.

10. The non-transitory computer readable medium of claim 9, wherein generating the first frame chunk comprises:
initializing a plurality of noise tokens; and
denoising the plurality of noise tokens based on the input prompt.

11. The non-transitory computer readable medium of claim 8, wherein:
the first frame chunk and the second frame chunk each include a plurality of overlapping tokens including an overlapping key frame token.

12. The non-transitory computer readable medium of claim 8, wherein:
the first frame chunk includes a first key frame, a first set of intermediate frames associated with the first key frame, a second key frame, and a second subset of intermediate frames from a second set of intermediate frames associated with the second key frame; and
the second frame chunk includes the second key frame, the second set of intermediate frames associated with the second key frame, a subsequent key frame, and a subsequent subset of intermediate frames associated with the subsequent key frame.

13. The non-transitory computer readable medium of claim 8, wherein generating the synthetic video comprises:
performing an interpolation between the first intermediate video frame and the second intermediate video frame in a pixel space.

14. The non-transitory computer readable medium of claim 8, wherein:
the video generation model is trained to generate overlapping frame chunks.

15. A system comprising:
a memory component; and
a processing device coupled to the memory component, the processing device configured to perform operations comprising:
obtaining an input prompt describing a scene;
generating, using a video generation model, a set of frame tokens including a first frame chunk and a second frame chunk based on the input prompt, wherein the first frame chunk includes a first token corresponding to a video frame and the second frame chunk includes a second token corresponding to the same video frame as the first token; and
generating, using the video generation model, a synthetic video based on the set of frame tokens including the first frame chunk and the second frame chunk, wherein the synthetic video depicts the scene and includes the video frame.

16. The system of claim 15, wherein:
the video generation model comprises a diffusion transformer encoder configured to generate the first frame chunk and the second frame chunk.

17. The system of claim 15, wherein:
the video generation model comprises a decoder configured to decode the first frame chunk and the second frame chunk.

18. The system of claim 15, wherein generating the synthetic video comprises:
generating a first intermediate video frame based on the first token and a second intermediate video frame based on the second token; and
blending the first intermediate video frame and the second intermediate video frame to obtain the video frame.

19. The system of claim 15, wherein generating the first frame chunk comprises:
initializing a plurality of noise tokens; and
denoising the plurality of noise tokens based on the input prompt.

20. The system of claim 15, wherein:
the video generation model is trained to generate overlapping frame chunks.
